(19) United States
(12) Patent Application Publication
(10) Pub. No.: US 2006/0198086 A1
(43) Pub. Date: Sep. 7, 2006

(54) Waterproof and heat-dissipating structure of computer keyboard

(76) Inventor: Frank Wang, Taipei (TW)

Correspondence Address: REED SMITH LLP, Suite 1400, 3110 Fairview Park, Falls Church, VA, 22042, US

(21) Appl. No.: 11/067,746

(22) Filed: Mar. 1, 2005

(51) Int. Cl. G06F 1/16

(52) U.S. Cl. 361/680

(57) ABSTRACT

The present invention provides a waterproof and heat-dissipating structure of a computer keyboard. The structure comprises a waterproof layer having an opening and a waterproof and air-permeable layer having the characteristics of waterproof, air permeability, thermal conductivity, temperature resistance, etc. and covering in the opening of the waterproof layer. The heat generated by electric components of a motherboard can be dissipated via the opening of the waterproof layer or a forced convection of sucking force of an internal fan, to enable cooling air to pass through the keyboard and penetrate the waterproof and air-permeable layer into the interior of the system to lower the motherboard's temperature. Thus, the efficacies of air-permeating and heat-dissipating are accomplished.

### BACKGROUND OF THE INVENTION

1. Field of the Invention

The present invention relates to a waterproof and heat-dissipating structure of a computer keyboard, particularly to a waterproof and heat-dissipating structure having characteristics of both waterproof and air-permeable and installed under the keyboard to dissipate the heat of a computer.

2. Description of the Related Art

Owing to the progress of science and technology, the computer has become very popular in families and companies. With the design of the computer trending to light, thin, short and small, the characteristic of lightweight and easy to carry makes the notebook computer become the mainstream in the market. In addition to light, thin, short and small, boost of computing speed is also a key point of the customer. The boost of computing speed of the notebook computer correspondingly results in increasing of heat generated by the operating electronic components in the motherboard. Once a large amount of accumulated heat cannot be dissipated, the operation of the notebook computer will be influenced or even crashed. Accordingly, the heat dissipation becomes an important subject.

The computer keyboard comprises key caps, linkages, rubber pads, a membrane circuit and an installing base, etc. All of above components typically reserve gaps for dissipating the heat. However, some users are used to put a cup of coffee or tea beside the keyboard. If the user is careless to spill the coffee or tea, the liquid of coffee or tea will pour into the keyboard through the gaps of the keyboard components into the motherboard and harm the motherboard seriously. Usually, a waterproof layer is installed under the keyboard to avoid any liquid penetration and protect the motherboard being harmed by liquids. However, the heat will unable to dissipate owing to the waterproof layer and induce overheat for the motherboard causing abnormal operation or even crash for the system.

The Taiwan patent No.433497 provides a keyboard structure with a waterproof and air-permeable layer, which utilizes a polymer material as the protective layer with a preferred embodiment of polytetrafluoroethylene (PTFE). However, the polymer material has a high flow-resistance and a poor thermal conductivity, so the heat-dissipating efficiency is hard to increase.

Accordingly, if a keyboard, which not only can avoid liquid's penetrating into the motherboard but also has well air-permeability, can be proposed, the aforementioned problem should be solved effectively.

### SUMMARY OF THE INVENTION

In the technical problems mentioned above, the primary objective of the present invention is to provide a waterproof and heat-dissipating structure of a computer keyboard, which not only can avoid malfunctions resulting from the liquid carelessly poured into the motherboard but also has the advantage of heat dissipating, so that the computer can well operate.

To achieve the aforementioned objective, the present invention provides a waterproof and heat-dissipating structure of a computer keyboard, which comprises a waterproof layer having an opening positioned on the heat source of the motherboard and a waterproof and air-permeable layer covering the opening of the waterproof layer.

In addition to the waterproof property of the waterproof and air-permeable layer to avoid liquid's penetrating into the motherboard, other characteristics such as air permeability, thermal conductivity, and temperature resistance are also very helpful to let the heat generated by the heat source of the motherboard to be dissipated via the opening or a forced convection of sucking force of an internal fan, to enable cooling air to pass through the keyboard and then penetrate the waterproof and air-permeable layer into the interior of the system to lower the motherboard's temperature. Thus, the efficacies of air-permeating and heat-dissipating are accomplished.

To enable the aforementioned objective, characteristics and advantage to be more easily understood, referring to the attached drawing, a preferred embodiment is described below in detail.

### BRIEF DESCRIPTION OF THE DRAWING

FIG. 1 is an exploded view of the waterproof and heat-dissipating structure of a computer keyboard according one aspect of the present invention.

### DETAILED DESCRIPTION OF THE PREFERRED EMBODIMENTS

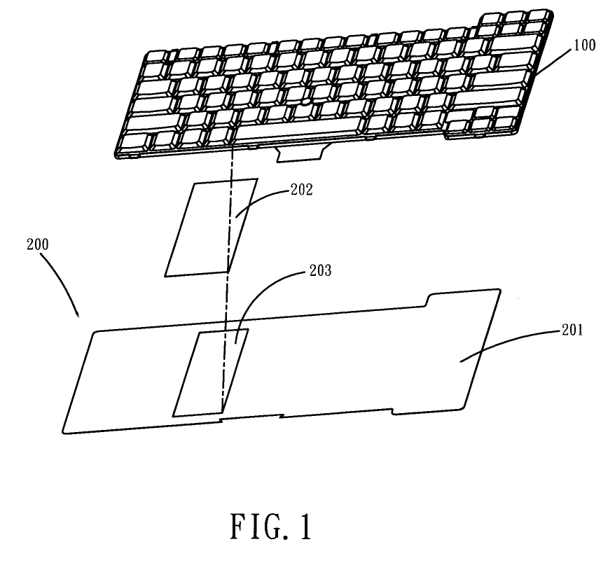

Referring to FIG. 1 an exploded view of the waterproof and heat-dissipating structure of a computer keyboard according one aspect of the present invention, a keyboard 100 typically comprises key caps, linkages, rubber pads, a membrane circuit, an installing base, and etc. All of components reserve gaps for dissipating the heat from the heat sources, such as the central processing unit (CPU) and video chipset, so the heat will not accumulate in the interior of a notebook computer and the notebook computer can well operate.

In order to avoid liquid penetrating those gaps to harm the motherboard, the present invention provides a waterproof and heat-dissipating structure 200 disposed under the keyboard 100. The waterproof and heat-dissipating structure 200 disposed under the keyboard 100 comprises a waterproof layer 201 and a waterproof and air-permeable layer 202, wherein the waterproof layer 201 has an opening 203 on heat source such as CPU or video chipset and the waterproof and air-permeable layer 202 covers the opening 203. The heat generated by the heat source can be dissipated via a natural convection through the waterproof and air-permeable layer 202 or a forced convection of sucking force of an internal fan (not shown), to enable cooling air to pass through the keyboard 100 and penetrate the waterproof and air-permeable layer 202 into the interior of the system to lower the motherboard's temperature. Thus, the efficacies of air-permeating and heat-dissipating are accomplished.

The waterproof layer 201 is made of a plastic material, such as polyester (PET), polyethylene (PE), polypropylene (PP), etc. and has waterproof and anti-static charge properties. If a user carelessly pours a liquid into the keyboard 100, the waterproof layer 201 can avoid malfunctions of the motherboard resulting from the liquid penetrating along the gaps of the key caps, linkages, rubber pads, membrane circuit and installing base into the motherboard. The waterproof and air-permeable layer 202 is made of a mesh-like material with a superior convective ability, such as polytetrafluoroethylene (PTFE), nickel, etc.

The thickness of the waterproof and air-permeable layer 202 is pretty thin, typically less than 0.01 mm, and disposed on the heat source, such as CPU or video chipset. Counting upon the characteristics of waterproof, air permeability, convective ability, temperature resistance, etc. of the waterproof and air-permeable layer 202, the heat generated by the heat source of the motherboard can be dissipated via a natural convection through the opening 203 covered by the waterproof and air-permeable layer 202, or a forced convection of sucking force of an internal fan, to enable cooling air to pass through the keyboard 100 and penetrate the waterproof and air-permeable layer 202 into the interior of the system to lower the motherboard's temperature.

The waterproof property of waterproof and air-permeable layer 202 is because the cohesive force of water itself is greater than the adhesion between water and the waterproof and air-permeable layer 202. The diameter of a water droplet typically ranges from 0.3 to 3 mm, while the diameter of the mesh of the waterproof and air-permeable layer 202 is less than 0.1 mm. That is reason why the waterproof and air-permeable layer 202 can be water-impermeable.

The design of the waterproof and heat-dissipating structure 200 formed jointly by the waterproof layer 201 and the waterproof and air-permeable layer 202 not only can prevent the liquid carelessly poured onto the keyboard 100 unable to penetrate into the motherboard, but also can dissipate the heat generated by the operating electronic elements of the notebook computer out of the keyboard 100 via a natural convection through the waterproof and air-permeable layer 202 or a forced convection of sucking force of an internal electric fan, to enable cooling air to pass through the keyboard 100 and penetrate the waterproof and air-permeable layer 202 into the interior of the system to lower the motherboard temperature, so the motherboard is protected and the heat will not accumulate inside the notebook computer.

Additionally, the high cost of waterproof and air-permeable layer 202 is only used on the heat source, such as CPU or video chipset, and on the rest of the portion, the low cost of waterproof layer 201 is adopted. Accordingly, the present invention not only has the waterproof and the heat-dissipating efficacies, but also can reduce the manufacturing cost. Thus, in comparison with the conventional waterproof keyboard, the present invention has an obvious improvement in the waterproof and the heat-dissipating functions, and the manufacturing cost thereof is obviously reduced.

Via the preferred embodiments, the present invention has been disclosed above; however, it is not intended to limit the scope of the present invention. Although equivalent modifications and variations can be easily accomplished by the persons skilled in the art, those are without departing from the spirit of the present invention and to be included within the scope of the present invention. The scope of the present invention is to depend on the appended claims stated below.

What is claimed is:

1. A waterproof and heat-dissipating structure of a computer keyboard, disposed under the computer keyboard, comprising:
a waterproof layer having an opening; and
a waterproof and air-permeable layer, which covers said opening of said waterproof layer.

2. The waterproof and heat-dissipating structure of a computer keyboard according to claim 1, wherein said opening of said waterproof layer is disposed on the heat source of the motherboard.

3. The waterproof and heat-dissipating structure of a computer keyboard according to claim 2, wherein said heat source is a central processing unit or a video chipset.

4. The waterproof and heat-dissipating structure of a computer keyboard according to claim 1, wherein said waterproof layer is made of a plastic material.

5. The waterproof and heat-dissipating structure of a computer keyboard according to claim 4, wherein said plastic material includes polyester, polyethylene, or polypropylene.

6. The waterproof and heat-dissipating structure of a computer keyboard according to claim 4, wherein said waterproof layer is made of an anti-static charge material.

7. The waterproof and heat-dissipating structure of a computer keyboard according to claim 1, wherein said waterproof and air-permeable layer is made of a mesh-like material with a convective ability.

8. The waterproof and heat-dissipating structure of a computer keyboard according to claim 7, wherein said mesh-like material has the mesh size of less than 0.1 mm.

9. The waterproof and heat-dissipating structure of a computer keyboard according to claim 7, wherein said mesh-like material includes polytetrafluoroethylene or nickel mesh.
